(19) United States
(12) Patent Application Publication
(10) Pub. No.: US 2025/0354484 A1
(43) Pub. Date: Nov. 20, 2025

(54) WELLBORE RESPONSE REMOVAL FROM ACOUSTIC NOISE LOGGING SIGNALS

(71) Applicant: Halliburton Energy Services, Inc., Houston, TX (US)

(72) Inventors: Murilo Marinho HENRICHS, Rio de Janeiro (BR); Francisco Alirio ALMEIDA GOMES DE MOURA, Rio de Janeiro (BR); Eduardo ALVES DA SILVA, Rio de Janeiro (BR); Yadong WANG, Singapore (SG); Rafael March CASTANEDA NETO, Rio de Janeiro (BR); Mahmoud SAADA, Spring, TX (US); Rafael Mazza BUCHMANN, Rio de Janeiro (BR); Leandro Teixeira VIANNA, Rio de Janeiro (BR)

(73) Assignee: Halliburton Energy Services, Inc., Houston, TX (US)

(21) Appl. No.: 18/923,493

(22) Filed: Oct. 22, 2024

Related U.S. Application Data
(60) Provisional application No. 63/648,855, filed on May 17, 2024.

(51) Int. Cl. E21B 47/14; G01V 1/50

(52) U.S. Cl. CPC E21B 47/14; G01V 1/50; E21B 2200/20; G01V 2200/16

(57) ABSTRACT

When a wellbore is manufactured or is operated, a wellbore defect can result in the wellbore failing. While hydrophones may be used to collect data indicative of a wellbore defect, reflections, oscillations, or harmonics of sounds indicative of the defect may result in inaccurate determinations being made. This is because such reflections, oscillations, or harmonics may mask the sounds that are indicative of the wellbore defect. As such, systems and methods of the present disclosure are directed to computer modeling techniques that simulate the effects of wellbore strata and structures such that these effects can be eliminated from datasets. By making more accurate determinations, safety of a wellbore may be enhanced. Methods of the present disclosure may be used to identify when a wellbore is safe to operate.

### CROSS-REFERENCE TO RELATED APPLICATIONS

This application claims benefit of U.S. Provisional Application No. 63/648,855 filed May 17, 2024, which is incorporated herein by reference.

### TECHNICAL FIELD

The present disclosure is generally directed to evaluating collected data when making determinations regarding the quality of a wellbore. More specifically, the present disclosure is directed to removing noise from collected acoustic data such that determinations regarding a wellbore environment may be more accurately performed.

### BACKGROUND

A wellbore or borehole is a hole that is drilled in the ground, often for the purpose of extracting substances (e.g., oil, natural gas, or water) or to provide substances into subterranean structures (e.g., carbon dioxide or hydraulic fracturing fluids). During virtually any phase of wellbore development, acoustic sensors may be used to collect data from which various determinations may be made. No matter what application an acoustic sensing system is applied to, unwanted noise associated with the wellbore environment may taint sets of collected data. This may increase the probability that determinations made by a sensing system using the collected data will be error prone.

### BRIEF DESCRIPTION OF THE DRAWINGS

In order to describe the manner in which the features and advantages of this disclosure can be obtained, a more particular description is provided with reference to specific implementations thereof which are illustrated in the appended drawings. Understanding that these drawings depict only exemplary implementations of the disclosure and are not therefore to be considered to be limiting of its scope, the principles herein are described and explained with additional specificity and detail through the use of the accompanying drawings in which:

FIG. 1A is a schematic diagram of an example logging while drilling wellbore operating environment, in accordance with various aspects of the subject technology.

FIG. 1B is a schematic diagram of an example downhole environment having tubulars, in accordance with various aspects of the subject technology, in accordance with various aspects of the subject technology.

FIG. 2 illustrates a wellbore tool that is offset from a center line of the wellbore, in accordance with various aspects of the subject technology.

FIG. 3 illustrates a cross-sectional view of a wellbore where a hydrophone is deployed and spectral content that may be associated with noise sensed by the hydrophone, in accordance with various aspects of the subject technology.

FIG. 4 illustrates two different graphs, a first graph that shows spectral content of three different types and a second graph that shows a power spectral density (PSD) versus relative depth plot of sound associated with a hydrophone, in accordance with various aspects of the subject technology.

FIG. 5 illustrates two different graphs, a first graph that shows spectral content of three different types and a second graph that shows a power spectral density (PSD) versus relative depth plot of sound associated with a hydrophone, in accordance with various aspects of the subject technology.

FIG. 6 illustrates two different graphs, a first graph that shows spectral content of three different types and a second graph that shows a power spectral density (PSD) versus relative depth plot of sound associated with a hydrophone, in accordance with various aspects of the subject technology.

FIG. 7 illustrates actions that may be performed when recommendations regarding resolving a condition associated with a wellbore sound source is identified, in accordance with various aspects of the subject technology.

FIG. 8 illustrates an example computing device architecture which can be employed to perform any of the systems and techniques described herein.

### DETAILED DESCRIPTION

Various aspects of the disclosure are discussed in detail below. While specific implementations are discussed, it should be understood that this is done for illustration purposes only. A person skilled in the relevant art will recognize that other components and configurations may be used without parting from the spirit and scope of the disclosure.

Additional features and advantages of the disclosure will be set forth in the description which follows, and in part will be obvious from the description, or can be learned by practice of the principles disclosed herein. The features and advantages of the disclosure can be realized and obtained by means of the instruments and combinations particularly pointed out in the appended claims. These and other features of the disclosure will become more fully apparent from the following description and appended claims or can be learned by the practice of the principles set forth herein.

It will be appreciated that for simplicity and clarity of illustration, where appropriate, reference numerals have been repeated among the different figures to indicate corresponding or analogous compounds. In addition, numerous specific details are set forth in order to provide a thorough understanding of the methods and apparatus described herein. However, it will be understood by those of ordinary skill in the art that the methods and apparatus described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the present disclosure.

When a wellbore is manufactured or is operated, a wellbore defect can result in the wellbore failing. While hydrophones may be used to collect data indicative of a wellbore defect, reflections, oscillations, or harmonics of sounds indicative of the defect may result in inaccurate determinations being made. This is because such reflections, oscillations, or harmonics may mask the sounds that are indicative of the wellbore defect. As such, systems and methods of the present disclosure are directed to computer modeling techniques that simulate the effects of wellbore strata and structures such that these effects can be eliminated from datasets. By making more accurate determinations, safety of a wellbore may be enhanced. Methods of the present disclosure may be used to identify when a wellbore is safe to operate.

As such, described herein are systems, apparatuses, processes (also referred to as methods), and computer-readable media (collectively referred to as “systems and techniques”) for improving an accuracy of sensed data and determinations made using collected data. Examples of the systems and techniques described herein are illustrated in the figures that follow.

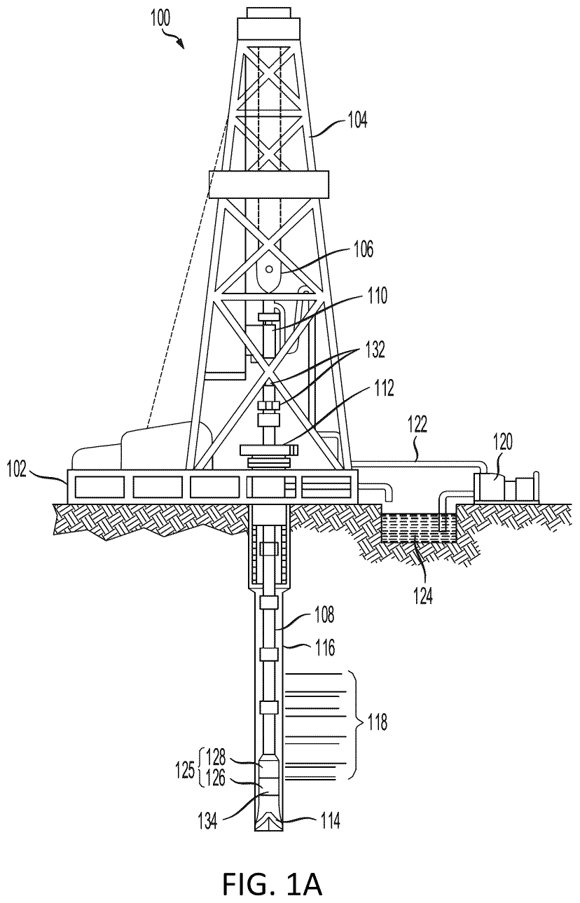

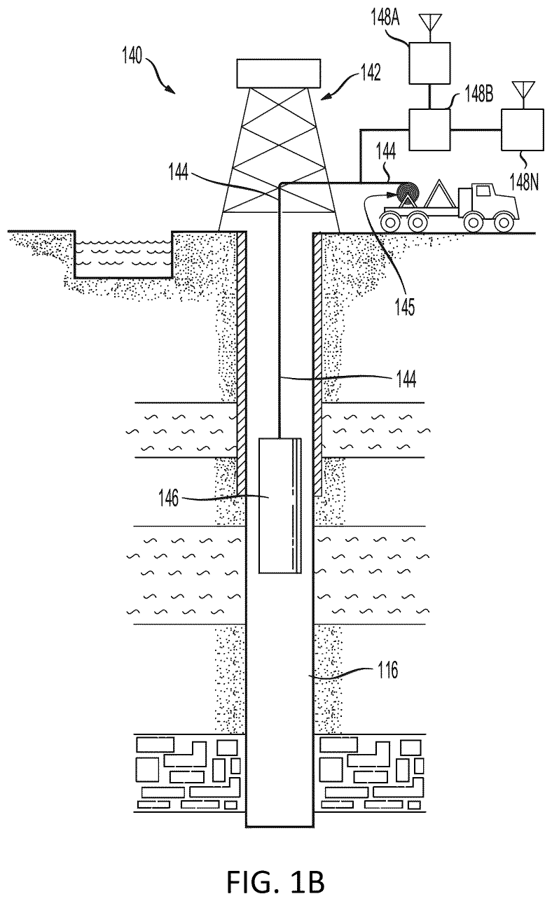

FIG. 1A is a schematic diagram of an example logging while drilling wellbore operating environment, in accordance with various aspects of the subject technology. The drilling arrangement shown in FIG. 1A provides an example of a logging-while-drilling (commonly abbreviated as LWD) configuration in a wellbore drilling scenario 100. The LWD configuration can incorporate sensors (e.g., EM sensors, seismic sensors, gravity sensor, image sensors, etc.) that can acquire formation data, such as characteristics of the formation, components of the formation, etc. For example, the drilling arrangement shown in FIG. 1A can be used to gather formation data through an electromagnetic imager tool (not shown) as part of logging the wellbore using the electromagnetic imager tool. The drilling arrangement of FIG. 1A also exemplifies what is referred to as Measurement While Drilling (commonly abbreviated as MWD) which utilizes sensors to acquire data from which the wellbore's path and position in three-dimensional space can be determined. FIG. 1A shows a drilling platform 102 equipped with a derrick 104 that supports a hoist 106 for raising and lowering a drill string 108. The hoist 106 suspends a top drive 110 suitable for rotating and lowering the drill string 108 through a well head 112. A drill bit 114 can be connected to the lower end of the drill string 108. As the drill bit 114 rotates, it creates a wellbore 116 that passes through various subterranean formations 118. A pump 120 circulates drilling fluid through a supply pipe 122 to top drive 110, down through the interior of drill string 108 and out orifices in drill bit 114 into the wellbore. The drilling fluid returns to the surface via the annulus around drill string 108, and into a retention pit 124. The drilling fluid transports cuttings from the wellbore 116 into the retention pit 124 and the drilling fluid's presence in the annulus aids in maintaining the integrity of the wellbore 116. Various materials can be used for drilling fluid, including oil-based fluids and water-based fluids.

Logging tools 126 can be integrated into the bottom-hole assembly 125 near the drill bit 114. As drill bit 114 extends into the wellbore 116 through the formations 118 and as the drill string 108 is pulled out of the wellbore 116, logging tools 126 collect measurements relating to various formation properties as well as the orientation of the tool and various other drilling conditions. The logging tool 126 can be applicable tools for collecting measurements in a drilling scenario, such as the electromagnetic imager tools described herein. Each of the logging tools 126 may include one or more tool components spaced apart from each other and communicatively coupled by one or more wires and/or other communication arrangement. The logging tools 126 may also include one or more computing devices communicatively coupled with one or more of the tool components. The one or more computing devices may be configured to control or monitor a performance of the tool, process logging data, and/or carry out one or more aspects of the methods and processes of the present disclosure.

The bottom-hole assembly 125 may also include a telemetry sub 128 to transfer measurement data to a surface receiver 132 and to receive commands from the surface. In at least some cases, the telemetry sub 128 communicates with a surface receiver 132 by wireless signal transmission (e.g., using mud pulse telemetry, EM telemetry, or acoustic telemetry). In other cases, one or more of the logging tools 126 may communicate with a surface receiver 132 by a wire, such as wired drill pipe. In some instances, the telemetry sub 128 does not communicate with the surface, but rather stores logging data for later retrieval at the surface when the logging assembly is recovered. In at least some cases, one or more of the logging tools 126 may receive electrical power from a wire that extends to the surface, including wires extending through a wired drill pipe. In other cases, power is provided from one or more batteries or via power generated downhole.

Collar 134 is a frequent component of a drill string 108 and generally resembles a very thick-walled cylindrical pipe, typically with threaded ends and a hollow core for the conveyance of drilling fluid. Multiple collars 134 can be included in the drill string 108 and are constructed and intended to be heavy to apply weight on the drill bit 114 to assist the drilling process. Because of the thickness of the collar's wall, pocket-type cutouts or other type recesses can be provided into the collar's wall without negatively impacting the integrity (strength, rigidity and the like) of the collar as a component of the drill string 108.

FIG. 1B is a schematic diagram of an example downhole environment having tubulars, in accordance with various aspects of the subject technology. In this example, an example system 140 is depicted for conducting downhole measurements after at least a portion of a wellbore has been drilled and the drill string removed from the well. An electromagnetic imager tool (not shown) can be operated in the example system 140 shown in FIG. 1B to log the wellbore. A downhole tool is shown having a tool body 146 in order to carry out logging and/or other operations. For example, instead of using the drill string 108 of FIG. 1A to lower the downhole tool, which can contain sensors and/or other instrumentation for detecting and logging nearby characteristics and conditions of the wellbore 116 and surrounding formations, a wireline conveyance 144 can be used. The tool body 146 can be lowered into the wellbore 116 by wireline conveyance 144. The wireline conveyance 144 can be anchored in the drill rig 142 or by a portable means such as a truck 145. The wireline conveyance 144 can include one or more wires, slicklines, cables, and/or the like, as well as tubular conveyances such as coiled tubing, joint tubing, or other tubulars. The downhole tool can include an applicable tool for collecting measurements in a drilling scenario, such as the electromagnetic imager tools described herein.

The illustrated wireline conveyance 144 provides power and support for the tool, as well as enabling communication between data processors 148A-N on the surface. In some examples, wireline conveyance 144 can include electrical and/or fiber optic cabling for carrying out communications. The wireline conveyance 144 is sufficiently strong and flexible to tether the tool body 146 through the wellbore 116, while also permitting communication through the wireline conveyance 144 to one or more of the processors 148A-N, which can include local and/or remote processors. The processors 148A-N can be integrated as part of an applicable computing system, such as the computing device architectures described herein. Moreover, power can be supplied via wireline conveyance 144 to meet power requirements of the tool. For slickline or coiled tubing configurations, power can be supplied downhole with a battery or via a downhole generator.

Holes are drilled into the Earth for purposes that include extracting hydrocarbons (oil and natural gas), accessing water, performing hydraulic fracturing, and sequestering materials like carbon dioxide in subterranean structures. Such holes or structures build into those holes may be referred to as a borehole or wellbore. In many instances, a hole drilled in the Earth may receive pipes that are referred to as a wellbore casing, this casing may be cemented in place. Furthermore, a cased wellbore may also include one or more tubes that may be used to deploy tools in the wellbore or that may be used to transport fluids either up the wellbore or down the wellbore.

When a wellbore is manufactured, a defect in cement can result in the wellbore failing. In certain instances, such failures could catastrophically destroy an operational wellbore. For example, in an instance when a void in cement that fastens a steel casing to subterranean strata, water (e.g., salt water) or caustic or acidic fluids may contact surfaces of the steel casing. Such a void may be an absence of cement that forms a channel that may allow fluids to flow to the casing. Actions that may be used to fill such a void may be based on the size and location of the void. This may result in the steel casing degrading (e.g., rusting). Such effects may be exacerbated by the temperature of the wellbore environment and by the motion of fluids moving through the subterranean strata and a channel. Methods of the present disclosure may be used to help qualify a wellbore for operation or continued operation.

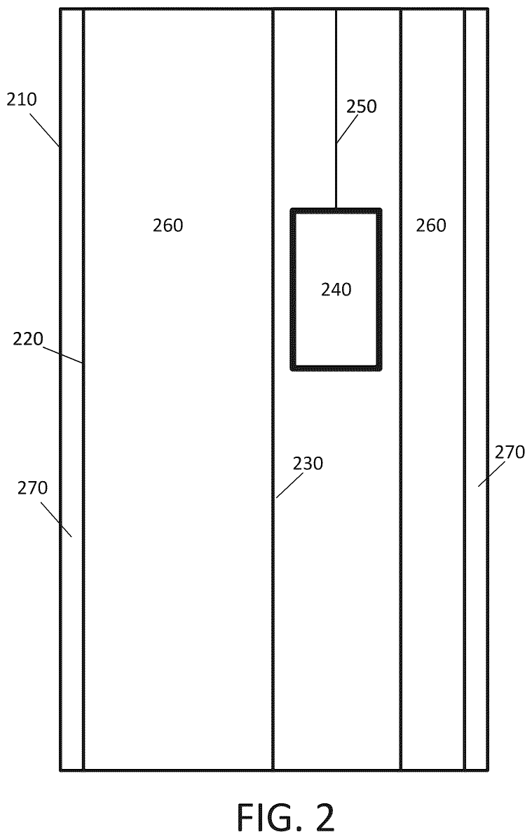

FIG. 2 illustrates a wellbore tool that is offset from a center line of a wellbore. FIG. 2 includes borehole 210, casing 220, tubing 230, and wellbore tool 240 that is deployed next to tubing 230 inside of casing 220 with deployment string 250. In certain instances, casing 220 may be cemented in place to wellbore 210 with cement 270. While wellbore tool 240 is illustrated as being deployed in tube 230, wellbore tools, like wellbore tool 240 can be deployed into the wellbore in space 260. Space 260 is an area within an inner portion of casing 220. Tubing 230 may be deployed within casing 230 such that one or more wellbore operations can be implemented. Tool 240 may include a hydrophone or may include an array of hydrophones. In certain instances, the hydrophone within tool 240 may be configured to operate passively. Passive operation may include collecting acoustic data from different locations of the wellbore when tool 240 does not transmit any acoustic stimulus energy.

A wellbore casing may contain multiple sets of tubing. Tubing 230 may be deployed in instances when borehole 210 will be used to extract oil or gas from a subterranean formation or when carbon dioxide is sequestered into the Earth next to borehole 210. While one casing and one set of tubing are illustrated in FIG. 2, systems and techniques of the present disclosure may be used in wellbores that include one or more casings and/or any number of sets of tubes that fit in a casing. This may mean that an imaging or sensing device may be located near multiple pipes (e.g., a steel casing, multiple steel tubes, or tubes/casings made of other materials).

Wellbore tool 240 may include imaging equipment that is used to collect data regarding formations that surround casing 220. While wellbore tool 240 and tubing 230 are both illustrated as being deployed in casing 220 of borehole 210 at locations that are offset from a center line of both casing 220 and borehole 210, a wellbore tool may be deployed down the center of casing 220. When wellbore tool 240 collects data, this data may include unwanted noise. When an acoustic sensing device is deployed in a wellbore, it may passively collect acoustic data. This acoustic data may include both unwanted noise and sounds generated by a source of interest. A particular source of interest may be associated with a wellbore defect. One type of defect is a void in cement that allows fluid to flow from the subterranean strata past the wellbore casing. Another type of defect is a crack or hole in the casing or in a tube deployed in the casing. Such cracks or holes can allow fluids to flow into a casing from either the subterranean environment or from a tube. Alternatively, or additionally, a defect could result in fluids moving into a tube from the casing. Methods of the present disclosure are not limited to identifying sound sources that are associated with a wellbore defect, however. As such, a sound source of interest may be the noise of fluids moving in strata that surround a wellbore. In such instances, sounds generated by the moving fluids may be used to identify whether an extraction process, a sequestration process, or a hydraulic fracturing process is proceeding according to a production plan. Because of this, methods of the present disclosure may help wellbores operate more safely or more effectively.

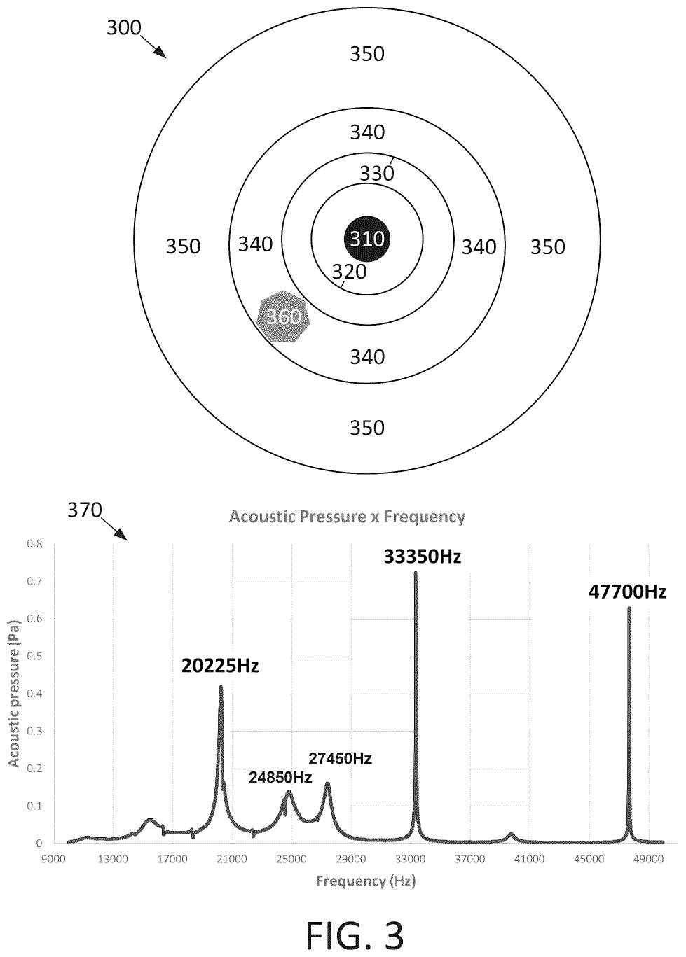

FIG. 3 illustrates a cross-sectional view of a wellbore where a hydrophone is deployed and spectral content that may be associated with noise sensed by the hydrophone. The cross-sectional view 300 of FIG. 3 includes hydrophone 310 deployed in tube 320 that is located within casing 330. Casing 330 is cemented to subterranean strata of the wellbore 350 with cement 340. Sound source 360 represents a sound source that may be a defect in cement 340. Here fluid from subterranean strata 350 may enter or move toward and/or around casing 330 via sound source 360.

FIG. 3 also includes graph 370 that plots amplitude of acoustic sound versus frequency. This acoustic noise of graph 370 is associated with wellbore noises that do not correspond to pure sounds generated by a sound source. The noise peaks in graph 370 may have been generated from reflections, oscillations, or harmonics generated from sound from a sound source. This means that sound from the sound source may interact with either wellbore structures or with strata that surrounds the wellbore in ways that degrade or distort the sound from the sound source. For example, noise from a sound source may reflect off surfaces, may induce resonances in structures (e.g., strata of the Earth or wellbore structures), or may generate harmonics that distort sound from the sound source. This means that spectral content included in graph 370 may be unwanted noise.

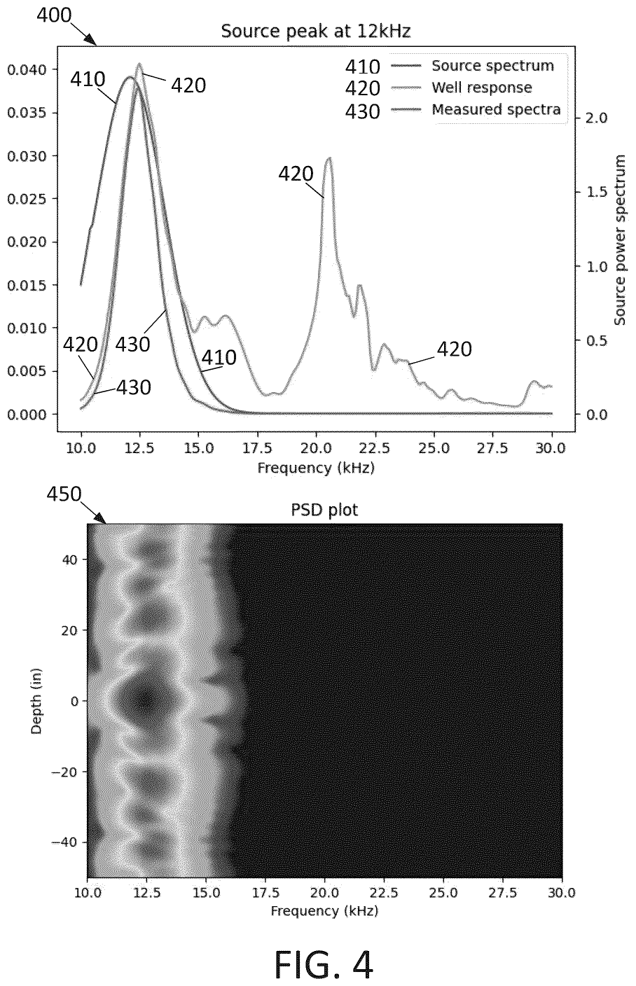

FIG. 4 illustrates two different graphs, a first graph that shows spectral content of three different types and a second graph that shows a power spectral density (PSD) versus relative depth plot of sound associated with a hydrophone. Graph 400 of FIG. 4 includes three different curves: a source spectrum curve 410 that has a single peak around 12 kHz; a well response curve 420 that has peaks near 12.5 kHz, 16 kHz, and 20 kHz; and spectral curve 430 that represents measured sound, curve 430 that has a single peak at about 12.5 kHz. Axes of graph 400 plot frequency against measures of acoustic power. As such each of the curves in FIG. 4 show acoustic power associated respectfully with a sound source of interest, distortion noise, and measured acoustic energy.

Here the source spectrum curve 410 identifies spectral content generated by a sound source. The well response curve 420 identifies spectral content caused by distortions (e.g., reflections, resonances/oscillations, or harmonics) generated by the presence of the sound from the sound source. The measured spectra curve 430 represents acoustic measurements made by a hydrophone deployed in a wellbore.

In ideal circumstances, sound from the sound source of interest (the source spectrum curve 410) would overlap with the measured spectra curve 430 as there would be no reflections, resonances, or harmonics (as shown by the spectral content of curve 420) that interfere with measuring sound from the sound source of interest. In this instance and without techniques of the present disclosure, making evaluations based on measured spectra alone would include at least some error based on differences between curve 410 and curve 430. Note that the actual sound generated by the sound source (curve 410) peaks at a slightly lower frequency and spans a broader frequency range than the sound of measured spectra curve 430.

Techniques of the present disclosure allow for the source spectrum curve 410 to be identified from data of the measured spectral curve 430 when well response noise of curve 420 masks or otherwise distorts sound from the sound source. Graph 450 is a PSD versus relative depth plot sound associated with a hydrophone. A center location of the sound source is located at depth of 0 inches in PSD plot 450.

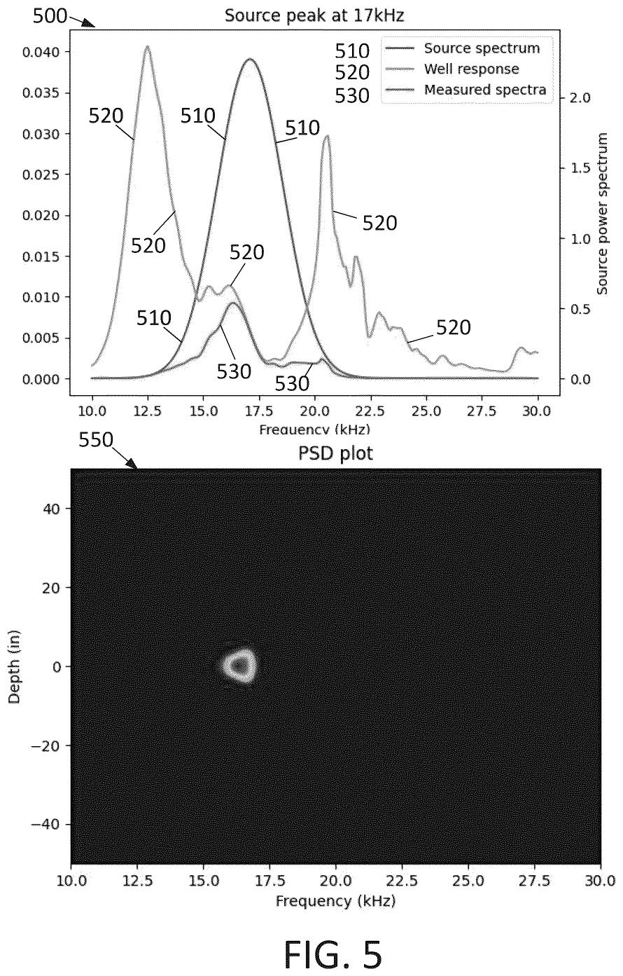

FIG. 5 illustrates two different graphs, a first graph that shows spectral content of three different types and a second graph that shows a power spectral density (PSD) versus relative depth plot of sound associated with a hydrophone. Graph 500 of FIG. 5 includes three different curves a source spectrum curve 510 that has a single peak around 17 kHz; a well response curve 520 that has peaks near 12.5 kHz, 16 kHz, and 20 kHz; and spectral curve 530 that represents measured sound, curve 530 has a peak located between 16 kHz and 17 kHz. Axes of graph 500 plot frequency against measures of acoustic power, as such each of the curves in FIG. 5 show acoustic power associated respectfully with a sound source of interest, distortion noise, and measured acoustic energy.

Here the source spectrum curve 510 identifies spectral content associated with a sound source. The well response curve 520 identifies spectral content caused by distortions (e.g., reflections, resonances/oscillations, or harmonics) generated by the presence of the sound from the sound source. The measured spectra curve 530 represents acoustic measurements made by a hydrophone deployed in a wellbore.

In ideal circumstances, sound from the sound source (the source spectrum curve 510) would overlap with the measured spectra curve 530 as there would be no reflections, resonances, or harmonics (as shown by the spectral content of curve 520) that interfere with measuring sound from the sound source of interest. In this instance and without techniques of the present disclosure, making evaluations based on measured spectra alone would include at least some error based on differences between curve 510 and curve 530. Once again, responses 520 that may include reflections, resonances/oscillations, or harmonics generated by the presence of the sound from the sound source 510 result in distortions to sounds that may have been directly measured in a wellbore.

Techniques of the present disclosure allow for the source spectrum curve 510 to be identified from data of the measured spectral curve 530 when well response noise of curve 520 masks or otherwise distorts sound from the sound source. Graph 550 is a PSD versus depth plot of sound associated with a hydrophone. Here again the sound source is located at reference depth of 0 inches.

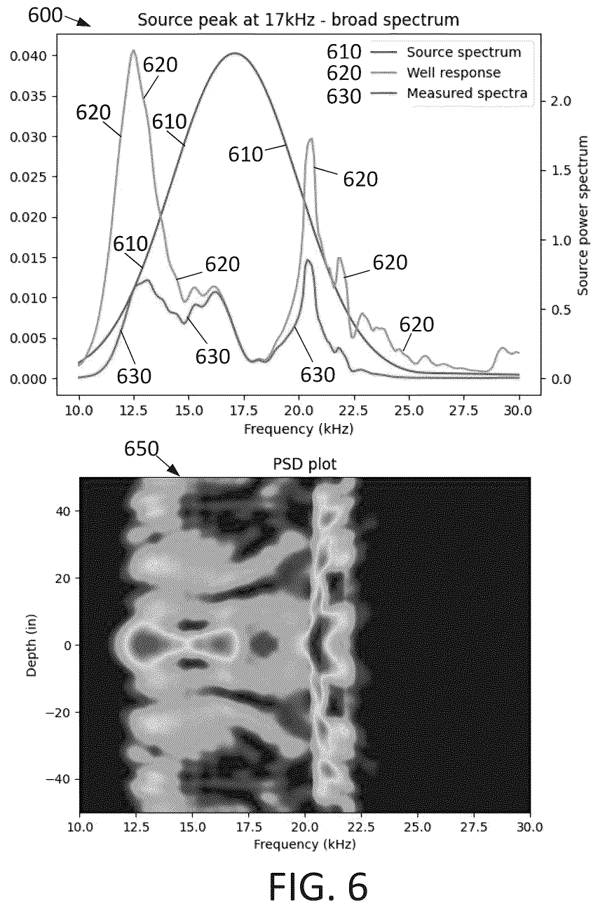

FIG. 6 illustrates two different graphs, a first graph that shows spectral content of three different types and a second graph that shows a power spectral density (PSD) versus relative depth plot of sound associated with a hydrophone. Graph 600 of FIG. 6 includes three different curves a source spectrum curve 610 that has a single peak around 17 kHz; a well response curve 620 that has peaks near 12.5 kHz, 16 kHz, and 20 kHz; and a measured spectral curve 630 that has a peak between 16 kHz and 17 kHz. Axes of graph 600 plot frequency against measures of acoustic power, as such each of the curves in FIG. 6 show acoustic power associated respectfully with a sound source of interest, distortion noise, and measured acoustic energy.

Here the source spectrum curve 610 identifies spectral content associated with a sound source. The well response curve 620 identifies spectral content caused by distortions (e.g., reflections, resonances/oscillations, or harmonics) generated by the presence of the sound from the sound source. The measured spectra curve 630 represents acoustic measurements associated with a hydrophone deployed in a wellbore.

In ideal circumstances, sound from the sound source (the source spectrum curve 610) would overlap with the measured spectra curve 630 as there would be no reflections, resonances, or harmonics (as shown by the spectral content of curve 620) that interfere with measuring sound from the sound source of interest. In this instance and without techniques of the present disclosure, making evaluations based on measured spectra alone would include at least some error based on differences between curve 610 and curve 630. Once again, responses 620 that may include reflections, resonances/oscillations, or harmonics generated by the presence of the sound from the sound source 610 result in distortions to sounds that may have been directly measured in a wellbore.

Techniques of the present disclosure allow for the source spectrum curve 610 to be identified from data of the measured spectral curve 630 when well response noise of curve 620 masks or otherwise distorts sound from the sound source. Graph 650 is a PSD versus depth plot sound associated with a hydrophone. Here again the sound source is located at reference depth of 0 inches.

The wellbore and its adjacencies are composed of many layers of materials with different material properties. These different layers, geometry of those layers, and parameters associated with those layers may be responsible for generating noise that masks or distorts the true character of sound from a sound source. As mentioned above, such distortions may be caused by reflections, resonances, or harmonics associated with the presence of materials that surround a wellbore. This distortion can be so severe, that sound from a sound source may appear to be shifted in frequency and in amplitude.

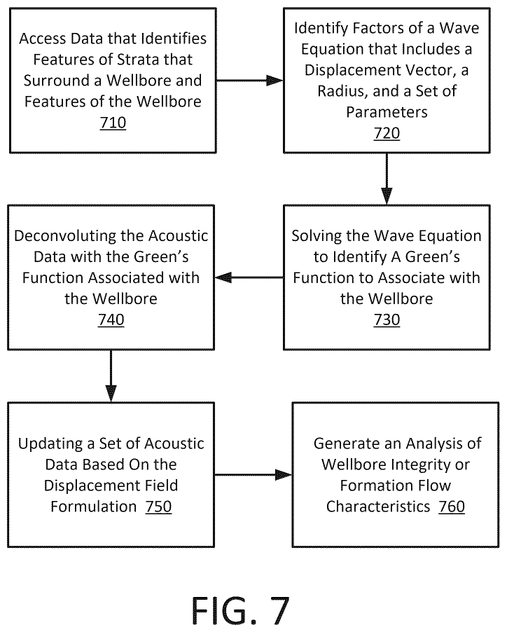

FIG. 7 illustrates actions that may be performed when recommendations regarding resolving a condition associated with a wellbore sound source are identified. Techniques of the present disclosure may use knowledge of the geometry and physical elasticity parameters of the media composing the layers, this signal distortion can be predicted, and its effect considered when interpreting the final data. An action performed at block 710 of FIG. 7 may include accessing data that identifies features of strata that surrounds a wellbore and that identifies features of the wellbore. This accessed data may include acoustic data that was acquired by one or sensors (e.g., hydrophones) that are deployed in a wellbore. Accessed data may include data that was acquired passively by sensors deployed in a wellbore. The features of the strata that surrounds the wellbore may include locations and geometry of specific types of strata, measures of elasticity of the strata, porosity, permeability, and/or density, for example. Any factor that may affect how acoustic waves propagate through, reflect off of, or generate oscillations in subterranean rocks or structures may be considered as a feature of the strata that surrounds the wellbore. In certain instances, data from acoustic logs or other logs may be accessed to identify features of the strata that surrounds the wellbore. Such acoustic log data or other types of log (e.g., electromagnetic log) data may be data that was acquired previously when a survey of the wellbore was performed using an active sensing system.

Features of the wellbore itself may include information relating to how a wellbore is constructed. As such, wellbore features may be associated with a type of casing (e.g., steel, composite, or other), a casing diameter, a type of tubing (e.g., steel, composite, or other), and/or a type of cement used to adhere the casing to structures of the wellbore. The data accessed at block 710 may be used as a basis to calculate frequency dependent distortions that likely would affect a sound source of a particular type. Accessed data may be used to identify resonate frequencies of substances or structures or may be used to identify the resonate frequency associated with a steel tube or casing. For example, sound generated by fluid leaking through a hole in a casing may have known characteristics when observed in isolation. When such a defect is located in a wellbore, noise generated by the leak may cause a resonance in structures that surround the casing whether those structures are manmade or natural. Reflections of the leak noise may also corrupt sounds recorded by a hydrophone.

Given an acoustic source with an arbitrary frequency content somewhere in the vicinity of the tool at a wellbore, frequency-dependent distortion caused at a point of measurement may be calculated by way of Green's function connecting the source to the receiver. Green's function may be considered a transfer function that models a systems output for different inputs or that models different outputs for different inputs. Green's function G may use a linear differential operator L, where the product of L and G equals Dirac's delta function d. As such L G=d. Dirac's delta function is a unit impulse function located at a position on a graph (e.g., at a zero position of the graph) that has an integral of one. As such, a plot of a pulse consistent with the Dirac's delta function will become narrower as a peak amplitude of the Dirac's delta function increases.

Assuming a model of linearly elastic media, the wave equation may be expressed by formula 1: (λ+μ)∇(∇·u(r))+μ∇²u(r)+ρω²u(r)=S(r,t). Here u is the displacement vector at position r, λ and μ are parameters that may be referred to as material Lamé parameters, S is a spatially and time varying source term, ρ is the material density, and ω is the wave angular frequency of the sound source. At block 720, displacement vector u position r, Lamé parameters λ and μ, a material density ρ, and angular velocity ω of the sound source may be identified, guessed, or approximated. Here Lamé parameter λ may identify mechanical strain and Lamé parameter u may identify mechanical stress. As such, a wave equation that includes one or more of a displacement vector, a radius, and a set of parameters may be identified at block 720. Additionally, or alternatively, at block 720, features of waveforms associated with the wellbore, formation geometries, and/or wellbore properties may be identified. These waveforms may be identified based on one or more sets of data. These waveforms may correspond to reflections, resonances/oscillations, or harmonics that may be caused by formations that surround the wellbore or by properties of the wellbore itself.

The Green's function from a source location r to a receiver r′ can be obtained at block 730 by solving the wave equation (formula 1) assuming a Dirac delta function (formula 2) as the source term representing a point source. Formula 2: (λ+μ)∇(∇·G(r,r′,t))+μ∇²G(r,r′,t)+ρω²G(r,r′,t)=δ(r).

The displacement field function at the location of the receiver caused by a sound source at location r′ can then be identified as the convolution between source and Green's function based on formula 3: u(r′,t)=G(r,r′,t)*S(t)⇒u(r′,ω)=G(r,r′,ω)S(ω) may processed. Green's function may be applied to deconvolute the accessed/acquired acoustic data at block 740.

This displacement field function may be in the form of a vector or may be a formulation descriptive of a pressure field. Such vectors of pressure field functions may associate the transfer of sound from a sound source to one or more acoustic sensors and because of this, these vectors or pressure field functions may be considered a transfer function. While not necessary, the displacement field function discussed above may be converted from being a time domain function to being a frequency domain.

The techniques of the present disclosure may allow a processor operating instructions of a computer model to calculate the influence of the borehole response on measured signal frequency spectra. The solution for the Green's function can be obtained through any numerical or analytical method. We can interpret the Green's function as a physical response of the system to an excitation caused by the source that shapes the signal that will be measured at the receiver position. This shaping function may contain several frequencies related to resonant frequencies of the wellbore which will be amplified in the final measurement, and some frequencies which will be more attenuated than others.

When analyzing the measured signal, one objective may be to make inferences about the frequency content of the source to characterize the fluid flows in and around the wellbore. As discussed above, this spectral content may be shaped by the borehole frequency response, application of borehole/wellbore physical factors may be used to predict/forecast shaping effects for a particular configuration of the wellbore. This in turn may be taken into account to avoid inaccurate/incorrect interpretations by minimizing or eliminating uncertainty about the origin of peaks in energy content by frequencies that might be related to the borehole resonant modes instead of an actual source signature. At block 750 a set of acoustic data (e.g., the data accessed/acquired at block 710) may be updated. This may be based on the displacement field formulation and, in certain instances, may also be based on the displacement field formulation being expressed in the frequency domain. The accessed set of acoustic data may correspond to the measured spectral data curves 430, 530, and 630 of FIGS. 4 through 6. This “measured spectral data” may be acoustic data that was measured in a wellbore with a hydrophone or may be simulated data classified as “measured spectral data.” The updated data may track the spectral content of the sound source and this may allow curve 430 of FIG. 4 to be converted into curve 410. Likewise, this may allow curve 530 of FIG. 5 and curve 630 of FIG. 6 to respectively be converted into curve 510 and curve 610 of FIGS. 5 and 6.

Simulations may be performed based on different types of sound sources that have different characteristics. The simulations may be used to identify correspondences between well response data, measured data, and sound source spectrum data. As such, methods of the present disclosure may deconvolute sets of convoluted data such that actual source spectrum data may be identified. Such correspondences may be identified in the virtual domain, with little or no actual recorded data. Actual data may then be collected by a hydrophone in a wellbore that may include defects. The mathematical evaluations of FIG. 7 may be performed based on known content and structure of strata surrounding the wellbore such that improved determinations regarding a type of wellbore defect and an extent of that defect. An analysis of wellbore integrity or formation flow characteristics may be generated at block 760. In certain instances, once the type and extent of a wellbore defect are identified, actions may be performed based on a recommendation made at block 760 of FIG. 7. In certain instances, techniques of the present disclosure may be used to identify that a wellbore does not include defects that could risk the wellbore and the wellbore may be authorized to perform operations based on such an identification. In an instance a wellbore defect is discovered, the recommendation may identify that the defect should be repaired. For example, when the defect is a crack in cement, a repair to that crack may be initiated based on the recommendation. As such a wellbore may be placed into service only when construction of the wellbore is deemed to meet a criterion of operation.

Since the techniques discussed herein remove ambiguity in sets of acquired data, these techniques may be applied to perform a process of “disambiguation” regarding data generated by the presence of a type of noise source.

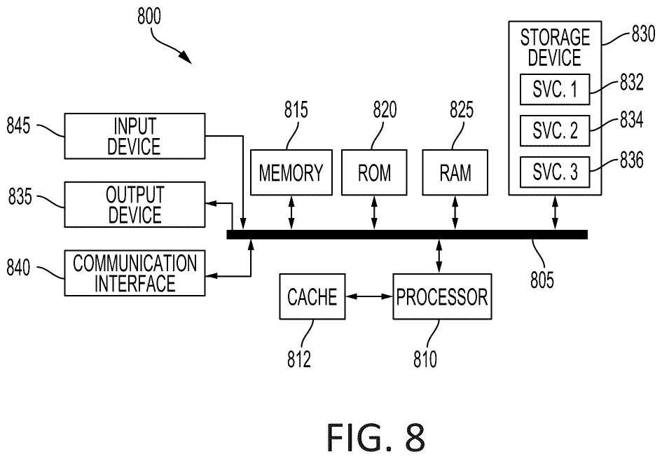

FIG. 8 illustrates an example computing device architecture which can be employed to perform any of the systems and techniques described herein. In some examples, the computing device 800 architecture can be integrated with tools described herein. The components of the computing device architecture 800 are shown in electrical communication with each other using a connection 805, such as a bus. The example computing device architecture 800 includes a processing unit (CPU or processor) 810 and a computing device connection 805 that couples various computing device components including the computing device memory 815, such as read only memory (ROM) 820 and random access memory (RAM) 825, to the processor 810.

The computing device architecture 800 can include a cache of high-speed memory connected directly with, in close proximity to, or integrated as part of the processor 810. The computing device architecture 800 can copy data from the memory 815 and/or the storage device 830 to the cache 812 for quick access by the processor 810. In this way, the cache can provide a performance boost that avoids processor 810 delays while waiting for data. These and other modules can control or be configured to control the processor 810 to perform various actions. Other computing device memory 815 may be available for use as well. The memory 815 can include multiple different types of memory with different performance characteristics. The processor 810 can include any general-purpose processor and a hardware or software service, such as service 1 832, service 2 834, and service 3 836 stored in storage device 830, configured to control the processor 810 as well as a special-purpose processor where software instructions are incorporated into the processor design. The processor 810 may be a self-contained system, containing multiple cores or processors, a bus, memory controller, cache, etc. A multi-core processor may be symmetric or asymmetric.

To enable user interaction with the computing device architecture 800, an input device 845 can represent any number of input mechanisms, such as a microphone for speech, a touch-sensitive screen for gesture or graphical input, keyboard, mouse, motion input, speech and so forth. An output device 835 can also be one or more of a number of output mechanisms known to those of skill in the art, such as a display, projector, television, speaker device, etc. In some instances, multimodal computing devices can enable a user to provide multiple types of input to communicate with the computing device architecture 800. The communications interface 840 can generally govern and manage the user input and computing device output. There is no restriction on operating on any particular hardware arrangement and therefore the basic features here may easily be substituted for improved hardware or firmware arrangements as they are developed.

Storage device 830 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 825, read only memory (ROM) 820, and hybrids thereof. The storage device 830 can include services 832, 834, 836 for controlling the processor 810. Other hardware or software modules are contemplated. The storage device 830 can be connected to the computing device connection 805. In one aspect, a hardware module that performs a particular function can include the software component stored in a computer-readable medium in connection with the necessary hardware components, such as the processor 810, connection 805, output device 835, and so forth, to carry out the function.

For clarity of explanation, in some instances the present technology may be presented as including individual functional blocks including functional blocks comprising devices, device components, steps or routines in a method implemented in software, or combinations of hardware and software.

In some instances, the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can include hardware, firmware and/or software, and can take any of a variety of form factors. Typical examples of such form factors include laptops, smart phones, small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples and aspects thereof, but those skilled in the art will recognize that the application is not limited thereto. Thus, while illustrative examples and aspects of the application have been described in detail herein, it is to be understood that the disclosed concepts may be otherwise variously embodied and employed, and that the appended claims are intended to be construed to include such variations, except as limited by the prior art. Various features and aspects of the above-described subject matter may be used individually or jointly. Further, examples and aspects of the systems and techniques described herein can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate examples, the methods may be performed in a different order than that described.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the method, algorithms, and/or operations described above. The computer-readable data storage medium may form part of a computer program product, which may include packaging materials.

The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

Methods and apparatus of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Such methods may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the above description, terms such as “upper,” “upward,” “lower,” “downward,” “above,” “below,” “downhole,” “uphole,” “longitudinal,” “lateral,” and the like, as used herein, shall mean in relation to the bottom or furthest extent of the surrounding wellbore even though the wellbore or portions of it may be deviated or horizontal. Correspondingly, the transverse, axial, lateral, longitudinal, radial, etc., orientations shall mean orientations relative to the orientation of the wellbore or tool.

The term “coupled” is defined as connected, whether directly or indirectly through intervening components, and is not necessarily limited to physical connections. The connection can be such that the objects are permanently connected or releasably connected. The term “outside” refers to a region that is beyond the outermost confines of a physical object. The term “inside” indicates that at least a portion of a region is partially contained within a boundary formed by the object. The term “substantially” is defined to be essentially conforming to the particular dimension, shape or another word that substantially modifies, such that the component need not be exact. For example, substantially cylindrical means that the object resembles a cylinder, but can have one or more deviations from a true cylinder.

The term “radially” means substantially in a direction along a radius of the object, or having a directional component in a direction along a radius of the object, even if the object is not exactly circular or cylindrical. The term “axially” means substantially along a direction of the axis of the object. If not specified, the term axially is such that it refers to the longer axis of the object.

Although a variety of information was used to explain aspects within the scope of the appended claims, no limitation of the claims should be implied based on particular features or arrangements, as one of ordinary skill would be able to derive a wide variety of implementations. Further and although some subject matter may have been described in language specific to structural features and/or method steps, it is to be understood that the subject matter defined in the appended claims is not necessarily limited to these described features or acts. Such functionality can be distributed differently or performed in components other than those identified herein. The described features and steps are disclosed as possible components of systems and methods within the scope of the appended claims.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Statements of the present disclosure include:

Statement 1: A method comprising: acquiring acoustic data with one or more sensors positioned in a wellbore; identifying features of recorded waveforms associated with the wellbore, formation geometries, or wellbore properties; solving a wave equation based on operation of a representative model of the wellbore to identify a Green's function to associate with the wellbore; deconvolving the acoustic data with the Green's function associated with the wellbore; and updating frequency spectra of the acoustic data by the one or more sensors when generating an updated set of acoustic data, wherein an analysis of wellbore integrity or formation flow characteristics is generated based on the updated frequency spectra of the updated set of acoustic data.

Statement 2: The method of statement 1, further comprising identifying a transfer function associated with transfer of sound from possible sound sources to the one or more sensors of a pressure field formulation based on solving the wave equation.

Statement 3: The method of statement 1 or statement 2, further comprising associating a type of sound source with the updated set of acoustic data.

Statement 4: The method of any of statements 1 through 3, further comprising identifying the features of the recorded waveforms based on an analysis of wellbore log data.

Statement 5: The method of any of statements 1 through 4, further comprising: performing an analysis that compares a source identification criterion with data from the updated set of acoustic data; and identifying that spectral content of a type of source meets the source identification criterion based on the updated set of acoustic data conforming to forecasted wellbore responses, wherein a recommendation identifies that the source meets the source identification criterion, and the wellbore is placed into service based on the recommendation.

Statement 6: The method of any of statements 1 through 5, wherein a/the type of sound source corresponds to a safe wellbore condition.

Statement 7: The method of statement 6, wherein the safe wellbore condition corresponds to a production flow.

Statement 8: A non-transitory computer-readable storage medium having embodied thereon instructions executable by one or more processors to implement a method comprising: acquiring acoustic data with one or more sensors positioned in a wellbore; identifying features of recorded waveforms associated with the wellbore, formation geometries, or wellbore properties; solving a wave equation based on operation of a representative model of the wellbore to identify a Green's function to associate with the wellbore; deconvolving the acoustic data with the Green's function associated with the wellbore; and updating frequency spectra of the acoustic data by the one or more sensors when generating an updated set of acoustic data, wherein an analysis of wellbore integrity or formation flow characteristics is generated based on the updated frequency spectra of the updated set of acoustic data.

Statement 9: The non-transitory computer-readable storage medium of statement 8, wherein the one or more processors execute the instructions to identify a transfer function associated with transfer of sound from possible sound sources to the one or more sensors of a pressure field formulation based on solving the wave equation.

Statement 10: The non-transitory computer-readable storage medium of statement 8 or 9, wherein the one or more processors execute the instructions to associate a type of sound source with the updated set of acoustic data.

Statement 11: The non-transitory computer-readable storage medium of any of statements 8 through 10, wherein the one or more processors execute the instructions to identify the features of the recorded waveforms based on an analysis of wellbore log data.

Statement 12: The non-transitory computer-readable storage medium of any of statements 8 through 11, wherein the one or more processors execute the instructions to perform an analysis that compares a source identification criterion with data from the updated set of acoustic data; and identify that spectral content of a/the type of source meets the source identification criterion based on the updated set of acoustic data conforming to forecasted wellbore responses, wherein a recommendation identifies that the source meets the source identification criterion, and the wellbore is placed into service based on the recommendation.

Statement 13: The non-transitory computer-readable storage medium of any of statements 8 through 12, wherein a/the type of sound source corresponds to a safe wellbore condition.

Statement 14: The non-transitory computer-readable storage medium of statement 13, wherein the safe wellbore condition corresponds to a production flow.

Statement 15: An apparatus comprising a memory; and one or more processors executed instructions out of the memory to: acquire acoustic data with one or more sensors positioned in a wellbore; identifying features of recorded waveforms associated with the wellbore, formation geometries, or wellbore properties; solve a wave equation based on operation of a representative model of the wellbore to identify a Green's function to associate with the wellbore; deconvolve the acoustic data with the Green's function associated with the wellbore; and update frequency spectra of the acoustic data by the one or more sensors when generating an updated set of acoustic data, wherein an analysis of wellbore integrity or formation flow characteristics is generated based on the updated frequency spectra of the updated set of acoustic data.

Statement 16: The apparatus of statement 15, wherein the one or more processors execute the instructions to identify a transfer function associated with transfer of sound from possible sound sources to the one or more sensors of a pressure field formulation based on solving the wave equation.

Statement 17: The apparatus of statement 15 or 16, wherein the one or more processors execute the instructions to associate a type of sound source with the updated set of acoustic data.

Statement 18: The apparatus of any of statements 15 through 17, wherein the one or more processors execute the instructions to identify the features of the recorded waveforms based on an analysis of wellbore log data.

Statement 19: The apparatus of any of statements 15 through 18, wherein the one or more processors execute the instructions to perform an analysis that compares a source identification criterion with data from the updated set of acoustic data; and identify that spectral content of a/the type of source meets the source identification criterion based on the updated set of acoustic data conforming to forecasted wellbore responses, wherein a recommendation identifies that the source meets the source identification criterion, and the wellbore is placed into service based on the recommendation.

Statement 20: The apparatus of any of statements 15 through 19, wherein a/the type of sound source corresponds to a safe wellbore condition.

What is claimed is:

1. A method comprising:
acquiring acoustic data with one or more sensors positioned in a wellbore;
identifying features of recorded waveforms associated with the wellbore, formation geometries, or wellbore properties;
solving a wave equation based on operation of a representative model of the wellbore to identify a Green's function to associate with the wellbore;
deconvolving the acoustic data with the Green's function associated with the wellbore; and
updating frequency spectra of the acoustic data by the one or more sensors when generating an updated set of acoustic data, wherein an analysis of wellbore integrity or formation flow characteristics is generated based on the updated frequency spectra of the updated set of acoustic data.

2. The method of claim 1, further comprising:
identifying a transfer function associated with transfer of sound from possible sound sources to the one or more sensors of a pressure field formulation based on solving the wave equation.

3. The method of claim 1, further comprising:
associating a type of sound source with the updated set of acoustic data.

4. The method of claim 1, further comprising:
identifying the features of the recorded waveforms based on an analysis of wellbore log data.

5. The method of claim 1, further comprising:
performing an analysis that compares a source identification criterion with data from the updated set of acoustic data; and
identifying that spectral content of a type of source meets the source identification criterion based on the updated set of acoustic data conforming to forecasted wellbore responses, wherein a recommendation identifies that the source meets the source identification criterion, and the wellbore is placed into service based on the recommendation.

6. The method of claim 1, wherein a type of sound source corresponds to a safe wellbore condition.

7. The method of claim 6, wherein the safe wellbore condition corresponds to a production flow.

8. A non-transitory computer-readable storage medium having embodied thereon instructions executable by one or more processors to implement a method comprising:
acquiring acoustic data with one or more sensors positioned in a wellbore;
identifying features of recorded waveforms associated with the wellbore, formation geometries, or wellbore properties;
solving a wave equation based on operation of a representative model of the wellbore to identify a Green's function to associate with the wellbore;
deconvolving the acoustic data with the Green's function associated with the wellbore; and
updating frequency spectra of the acoustic data by the one or more sensors when generating an updated set of acoustic data, wherein an analysis of wellbore integrity or formation flow characteristics is generated based on the updated frequency spectra of the updated set of acoustic data.

9. The non-transitory computer-readable storage medium of claim 8, wherein the one or more processors execute the instructions to:
identify a transfer function associated with transfer of sound from possible sound sources to the one or more sensors of a pressure field formulation based on solving the wave equation.

10. The non-transitory computer-readable storage medium of claim 8, wherein the one or more processors execute the instructions to:
associate a type of sound source with the updated set of acoustic data.

11. The non-transitory computer-readable storage medium of claim 8, wherein the one or more processors execute the instructions to:
identify the features of the recorded waveforms based on an analysis of wellbore log data.

12. The non-transitory computer-readable storage medium of claim 8, wherein the one or more processors execute the instructions to:
perform an analysis that compares a source identification criterion with data from the updated set of acoustic data; and
identify that spectral content of a type of source meets the source identification criterion based on the updated set of acoustic data conforming to forecasted wellbore responses, wherein a recommendation identifies that the source meets the source identification criterion, and the wellbore is placed into service based on the recommendation.

13. The non-transitory computer-readable storage medium of claim 8, wherein a type of sound source corresponds to a safe wellbore condition.

14. The non-transitory computer-readable storage medium of claim 13, wherein the safe wellbore condition corresponds to a production flow.

15. An apparatus comprising:
a memory; and
one or more processors executed instructions out of the memory to:
acquire acoustic data with one or more sensors positioned in a wellbore;
identifying features of recorded waveforms associated with the wellbore, formation geometries, or wellbore properties;
solve a wave equation based on operation of a representative model of the wellbore to identify a Green's function to associate with the wellbore;
deconvolve the acoustic data with the Green's function associated with the wellbore; and
update frequency spectra of the acoustic data by the one or more sensors when generating an updated set of acoustic data, wherein an analysis of wellbore integrity or formation flow characteristics is generated based on the updated frequency spectra of the updated set of acoustic data.

16. The apparatus of claim 15, wherein the one or more processors execute the instructions to:
identify a transfer function associated with transfer of sound from possible sound sources to the one or more sensors of a pressure field formulation based on solving the wave equation.

17. The apparatus of claim 15, wherein the one or more processors execute the instructions to:
associate a type of sound source with the updated set of acoustic data.

18. The apparatus of claim 15, wherein the one or more processors execute the instructions to:
identify the features of the recorded waveforms based on an analysis of wellbore log data.

19. The apparatus of claim 15, wherein the one or more processors execute the instructions to:
perform an analysis that compares a source identification criterion with data from the updated set of acoustic data; and
identify that spectral content of a type of source meets the source identification criterion based on the updated set of acoustic data conforming to forecasted wellbore responses, wherein a recommendation identifies that the source meets the source identification criterion, and the wellbore is placed into service based on the recommendation.

20. The apparatus of claim 15, wherein a type of sound source corresponds to a safe wellbore condition.
